(19) United States
(12) Patent Application Publication
(10) Pub. No.: US 2004/0136376 A1
(43) Pub. Date: Jul. 15, 2004

(54) Processing of segmented messages

(76) Inventor: Kari Einamo, Kangasala (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/476,216

(22) PCT Filed: May 3, 2001
(86) PCT No.: PCT/EP01/05009

(51) Int. Cl. H04Q 7/00

(52) U.S. Cl. 370/394; 370/329

(57) ABSTRACT

According to the present invention, a message is sent from a first network element in a mobile communication network to a second network element in several segments, using an application produced. To the last segment of the message a parameter is added, which indicates the number of segments of the message. At the second network element, received message segments are counted, and the number of counted message segments is compared with the number indicated by the parameter. If a mismatch of the numbers is detected, the message is discarded at the second network element.

### FIELD OF THE INVENTION

The present invention relates to mobile communication networks, and in particular to application layer messages which are sent between network elements and are allowed to be segmented.

### BACKGROUND OF THE INVENTION

A message sent from a first network element in a mobile communication network to a second network element using an application protocol may be so large that it does not fit into one transfer layer message. In case the application protocol allows a segmentation of the message at the application protocol level, after segmentation, at least one non-last-component and one last-component of the segmented message is sent from the first network element to the second network element.

However, in case a non-last-component is lost during transmission, the second network element does not necessarily detect such a loss and processes the received fragmentary message.

### SUMMARY OF THE INVENTION

It is an object of the present invention to enhance a correct processing of segmented messages.

According to the present invention, this object is achieved by a method and a system for detecting a message segment loss according to claims 1 and 5. Moreover, this object is achieved by network elements according to claims 6 and 7.

Further features of the present invention are defined in the dependent claims.

According to the present invention, a message is sent from a first network element in a mobile communication network to a second network element in several segments, using an application protocol. To the last segment of the message a parameter is added, which indicates the number of segments of the message. At the second network element, received message segments are counted, and the number of counted message segments is compared with the number indicated by the parameter. If a mismatch of the numbers is detected, the message is discarded at the second network element.

According to the present invention, a detection of the loss of message segments is enabled so that a fragmentary message may be discarded. Hence, an otherwise incorrect processing of the fragmentary message can be avoided.

### BRIEF DESCRIPTION OF THE DRAWINGS

FIG. 1 shows a message segment loss without detection.

FIG. 2 shows a message segment loss with detection according to an embodiment of the present invention.

### DETAILED DESCRIPTION OF THE INVENTION

In the following the present invention will be described by means of an embodiment thereof. In this embodiment, a network element sending a segmented message is represented by an HLR (Home Location Register), and a network element receiving message segments is represented by a GMSC (Gateway Mobile Switching Center). The segmented message is an MAP SRI ack (Mobile Application Part Send Routing Information acknowledge) message which is sent from the HLR to the GMSC when the HLR receives a MAP SRI message from the GMSC.

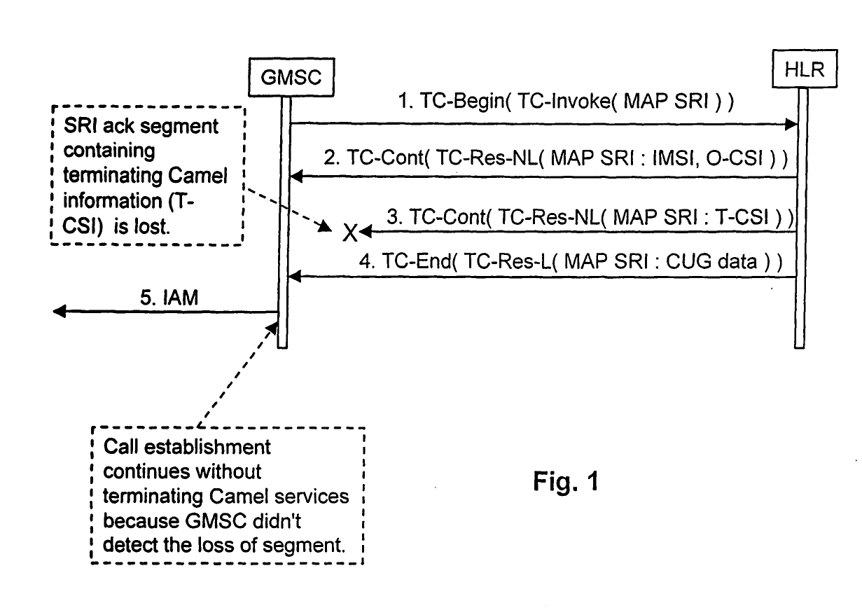

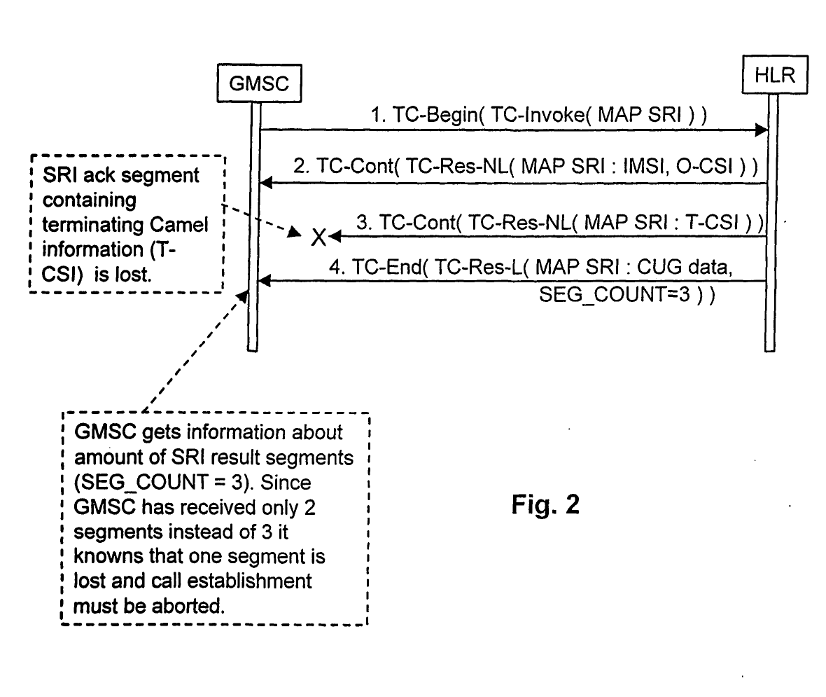

According to FIGS. 1 and 2, the GMSC uses an SRI operation to request routing information from the HLR for a mobile terminated call, which is indicated by a communication 1. With MAP version 3 response for the SRI operation can be so large that it does not fit into one MTP (Message Transfer Part) layer message. The MAP specification allows segmentation of the SRI response to be done at the MAP level. In other words, the several TC-Result-Not-Last components containing SRI result data are sent to the GMSC (communications 2 and 3) before a TC-Result-Last component is sent (communication 4). The TC-Result-Last component is always the last component if a positive response is sent on the SRI operation.

As shown in FIGS. 1 and 2, the SRI ack segment according to communication 3 is lost. For example, this lost segment contains terminating CAMEL (Customized Application for Mobile network Enhanced Logic) information (T-CSI).

In FIG. 1, the GMSC does not detect the loss of the SRI ack segment according to communication 3, which may lead to unexpected results in call handling. In the present case, call establishment is continued (communication 5: IAM) without terminating CAMEL services since the GMSC did not detect the loss of the T-CSI segment. For example, with the T-CSI segment some of CAMEL data of a prepaid subscriber is lost. Thus, the GMSC is not able to activate prepaid control and the call may succeed even if the subscriber has no credit. Same applies to all CAMEL services which are invoked by the GMSC. And there may be also other parameters which affect to the call handling, like information related to Closed-User Group and Equal Access.

If the GMSC is able to detect the loss of segments call handling can be interrupted. By interrupting the call establishment the possibility to establish a call which violates the service profile of the called subscriber is prevented.

According to the embodiment and as shown in FIG. 2, a new parameter is added to the SRI ack message. The parameter is to be sent in the last segment (TC-Result-Last; communication 4 in FIG. 2) and it is used to indicate how many segments were used to transfer SRI ack data. If the GMSC receives the information about the amount of segments it can check whether all segments have been received or not. If not all segments have been received call establishment will be aborted. In other words, the GMSC counts the amount of received segments, and detects whether a parameter indicating the number of segments of the message is added to the last segment of the message. If the last segment contains the amount of sent segments the GMSC compares this value with the received amount. In case of mismatch call handling is aborted. In FIG. 2, the GMSC gets information about the amount of SRI result segments (SEG COUNT=3) with communication 4. Since the GMSC has received only two segments instead of three it is able to recognize that one segment must have been lost and that call establishment must be aborted.

If the GMSC detects that the parameter is not added to the last segment, it skips the comparing and mismatch detecting operations. In other words, in case the parameter has not been added to the last segment, the received fragmentary message is processed by the GMSC as shown in FIG. 1.

According to the embodiment, the new parameter may be added to MAP specifications as integer type parameter to SRI result.

While the invention has been described with reference to a preferred embodiment, the description is illustrative of the invention and is not to be construed as limiting the invention. Various modifications and applications may occur to those skilled in the art without departing from the true spirit and scope of the invention as defined by the appended claims.

1. A method of detecting a message segment loss, said method comprising the steps of:
sending a message from a first network element in a mobile communication network to a second network element using an application protocol, the message being sent in several segments;
adding a parameter to the last segment of the message, the parameter indicating the number of segments of the message;
counting received message segments at the second network element;
comparing the number of counted message segments with the number indicated by the parameter; and
if a mismatch of the numbers is detected, discarding the message at the second network element.

2. A method according to claim 1, wherein the application protocol comprises MAP protocol.

3. A method according to claim 2, wherein the message is an SRI acknowledge message sent from an HLR to a GMSC.

4. A method according to claim 3, wherein the parameter is added to a TC-Last-Result segment of the SRI acknowledge message.

5. A mobile communication network system for detecting a message segment loss, said system comprising:
a first network element being arranged to send a message in several segments to a second network element, using an application protocol,
wherein said first network element is arranged to add a parameter to the last segment of the message, the parameter indicating the number of segments of the message,
wherein said second network element is arranged to count the number of received message segments and to compare the number of counted message segments with the number indicated by the parameter, and
wherein, if said second network element detects a mismatch of the numbers, it is arranged to discard the message.

6. A network element in a mobile communication network for detecting a message segment loss, said network element being arranged to send a message in several segments using an application protocol,
wherein said network element is arranged to add a parameter to the last segment of the message, the parameter indicating the number of segments of the message.

7. A network element in a mobile-communication network for detecting a message segment loss, said network element being arranged to
receive segments of a message,
count the number of received message segments,
detect whether a parameter indicating the number of segments of the message is added to the last segment of the messaged, and,
if the parameter is added, compare the number of counted message segments with the number indicated by the parameter,
wherein, if said network element detects a mismatch of the numbers, it is arranged to discard the message.

8. A network element according to claim 7, wherein, if said network element detects that the parameter is not added, it is arranged to skip the comparing and mismatch detecting operations.
